(19) United States
(12) Patent Application Publication
(10) Pub. No.: US 2022/0351072 A1
(43) Pub. Date: Nov. 3, 2022

(54) TIMESERIES DATA TRAINING DATA SET SELECTION FOR ANOMALY DETECTION

(71) Applicant: International Business Machines Corporation, Armonk, NY (US)

(72) Inventors: Mansoor Ahmed, Bangalore (IN); Liyan Fang, Austin, TX (US); Sattwati Kundu, Bangalore (IN); Raghunath E. Nair, Bangalore (IN)

(21) Appl. No.: 17/246,901

(22) Filed: May 3, 2021

(51) Int. Cl. G06N 20/00

(52) U.S. Cl. CPC G06N 20/00

(57) ABSTRACT

Selecting a timeseries data set by determining a data quality score and seasonality period for each segment of a set of timeseries data segments, determining a most frequent seasonality period for the set of timeseries data segments, determining an average data quality score for a set of timeseries data segments having the most frequent seasonality period, forming a timeseries data set from the set of segments having the most frequent seasonality period, according to a desired data quality score, and providing the timeseries data set for training a machine learning model.

### FIELD OF THE INVENTION

The disclosure relates generally to the selection of training data for a machine learning model. The disclosure relates particularly to selecting a timeseries data set for training a machine learning model for anomaly detection.

### BACKGROUND

Training a machine learning model requires a training data set. The quality of the trained model reflects the quality of the training data. Better training data results in a better model. Models may be trained to detect anomalies in new data, including timeseries data.

### SUMMARY

The following presents a summary to provide a basic understanding of one or more embodiments of the disclosure. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatuses and/or computer program products enable selection of timeseries training data sets.

Aspects of the invention disclose methods, systems and computer readable media associated with selecting a timeseries data set by determining a data quality score and seasonality period for each segment of a set of timeseries data segments, determining, a most frequent seasonality period for the set of timeseries data segments, determining an average data quality score for a set of timeseries data segments having the most frequent seasonality period, forming a timeseries data set from the set of segments having the most frequent seasonality period, according to a desired data quality score, and providing the timeseries data set for training a machine learning model.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 provides a schematic illustration of a computing environment, according to an embodiment of the invention.

FIG. 2 provides a flowchart depicting an operational sequence, according to an embodiment of the invention.

FIG. 3 depicts a cloud computing environment, according to an embodiment of the invention.

FIG. 4 depicts abstraction model layers, according to an embodiment of the invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

A model trained to detect anomalies in timeseries data identifies anomalies as deviations from normal, including deviations from normal timeseries data patterns. Training such models requires a training data set selected with consideration for the timeseries data patterns of the typical data. Training data sets selected without proper regard for normal timeseries data patterns in the data result in poorly trained models. Disclosed embodiments enable the selection of training data sets based upon the statistical data quality of available data, and determination of normal seasonality patterns for the typical new data.

Unsupervised anomaly detection is based on a prediction result. Therefore, prediction accuracy is important. However, overfitting the model to a local optimum or other local feature, needs to be avoided. Model accuracy may vary according to the training data set and may be improved by selecting different training windows. Disclosed embodiments detect a normal pattern using the most common seasonality period identified among all rolling window data segments, which helps avoid overfitting problem and avoids the training data and associated machine learning model being affected by fast-changing patterns.

Aspects of the present invention relate generally to the selection of training data for machine learning models. Specifically, aspects relate to the selection of training windows incorporating timeseries data having representative seasonality patterns from all available data. Proper window selection enables the trained model to detect anomalies in new data as the model has been trained using a dataset which includes the normal patterns for the target data. Aspects determine a data quality score for potential training data. Methods determine the most frequent seasonality period found in the available data set and then determine an overall data quality score for each time window which includes the most frequent seasonality period. A further quality check includes evaluating the average quality score for the set of windows against a desired data quality score. The method includes sets of windows each having the most frequent seasonality period and having an average data quality score for the set which is greater than or equal to the desired score, as the timeseries training data set. Disclosed methods reduce sets of windows having an average quality score less than the desired score by removing all windows having an overall quality score less than or equal to the median of the overall set of windows.

Aspects of the invention provide an improvement in the technical field of selecting machine learning model timeseries training data sets. Aspects select high quality training data embodying the normal patterns against which anomaly identification is desired. The high quality of the data together with the inclusion of time windows incorporating the normal patterns reduces the likelihood of overfitting the model. Selecting windows using the most frequently occurring seasonality period of the available data set increases the likelihood that the training data will include the normal patterns found in the available data.

Aspects of the invention also provide an improvement to computer functionality. In particular, implementations of the invention are directed to a specific improvement to the selection of timeseries training data to include normal data patterns. Inclusion of normal patterns by selection of timeseries data windows having the most common seasonality period found in the available data reduces the possibility of overfitting the model to a local optimum and excluding the normal data patterns. Providing model strained to detect anomalies relative to normal patterns which are not overfitted to a local optimum improves system functionality.

In an embodiment, one or more components of the system can employ hardware and/or software to solve problems that are highly technical in nature (e.g., determining a data quality score and seasonality period for each segment of a set of timeseries data segments, determining a most frequent seasonality period frequency for the set of timeseries data segments, determining an average data quality score for a set of timeseries data segments having the most frequent seasonality period, forming a timeseries data set from segments having the most frequent seasonality period, according to a desired data quality score, providing the timeseries data set for training a machine learning model, etc.). These solutions are not abstract and cannot be performed as a set of mental acts by a human due to the processing capabilities needed to facilitate timeseries data training dataset selection, for example. Further, some of the processes performed may be performed by a specialized computer for carrying out defined tasks related to training data set selection. For example, a specialized computer can be employed to carry out tasks related to the selection, or the like.

In an embodiment, the method analyzes a timeseries data set relevant to the desired model using data quality analytics and determines the data quality metrics having the greatest influence on potential model outcomes. The method identifies the relative importance of the respective data metrics and assigns weights to the metrics. Assigning higher weighting values to more important metrics. In this embodiment, data quality metrics include duplicates, unordered timestamps, uniform sampling rate, missing timestamps, missing values, seasonality, trend, outliers, stationarity etc.

As an example, for an application used for time series data with obvious seasonality and trend, the method assigns higher weights for seasonality metric and trend metric. For the example, data quality metrics have weights of: seasonality: 0.3, trend: 0.3, missing timestamps: 0.15, missing values: 0.15, and stationarity: 0.1.

As a second example, an application for time series data and sensitive to missing values and outliers has higher weight values assigned to those metrics. For the example, data quality metrics of: missing timestamps: 0.3, missing values: 0.3, outliers: 0.3, and stationarity: 0.1

The method considers the data in segments. Each segment includes consecutive timeseries data for a specified time duration, e.g., twenty-four hours, seventy-two hours, a week, etc. The method utilizes a sliding or rolling window in defining the segments, such as a twenty-four-hour window shifted one hour at a time over the set of timeseries data to provide a series of twenty-four-hour segments. The method evaluates the data using multiple sliding window durations, producing multiple sets of data segments. In an embodiment, the method uses a single fixed length window duration producing a single set of data segments.

For either multiple window durations, or a single window duration, the method computes a cumulative data quality score for each segment of the data set(s) using the weighted data quality metrics described above. For each segment, the method further determines a seasonality period. In an embodiment, the method determines the seasonality period by evaluating the timeseries segments with respect to data value trends to determine the seasonality period. Seasonality period refers to the time frame associated with repeating patterns in the timeseries data. For example, hourly data having a pattern which repeats every seven days has a seasonality period of 160 hours. In an embodiment, the method uses an autocorrelation method to identify seasonality patterns ad determines the seasonality period for the data patterns as that period having the highest correlation.

In an embodiment, the method evaluates the seasonality periods of the segments of a set of segments and identifies the most frequent seasonality period for the segments of the set. In this embodiment, the method determines the average data quality score for the subset of data segments having the most frequently occurring seasonality period. As an example, for a set of timeseries segments having twenty-four hours as the most frequently occurring seasonality period, the method averages the data quality scores for all segments of the set having a twenty-four-hour seasonality period, ignoring any segments of the set having a seasonality period other than twenty-four hours.

In an embodiment, a subject matter expert familiar with the data and the desired model outcomes, defines a desired data quality score for the training data set. The desired data quality score indicates the level of data quality acceptable for the training data set. In an embodiment, the method compares the average data quality score for the segments having the most frequent seasonality period to the desired data quality score. For subsets of segments having the most frequent seasonality period and an average data quality score equal to or exceeding the desired data quality score, the method merges all the segments of the subset into the training data set for the model.

In an embodiment, for subsets having the most frequent seasonality period where the average data quality score for the subset is less than the desired data quality score, the method determines the median data quality score of the subset and then forms the training data set by merging all segments from the subset of segments having the most frequent seasonality period having a segment data quality score greater than the median data quality score for the subset.

In an embodiment, after merging the appropriate segments to form the training data set, the method provides the training data set to a user for training the machine learning model. The user trains the machine learning model using the training data set. In an embodiment, the user splits the training data set, reserving a portion of the training data set as test data to validate the trained model.

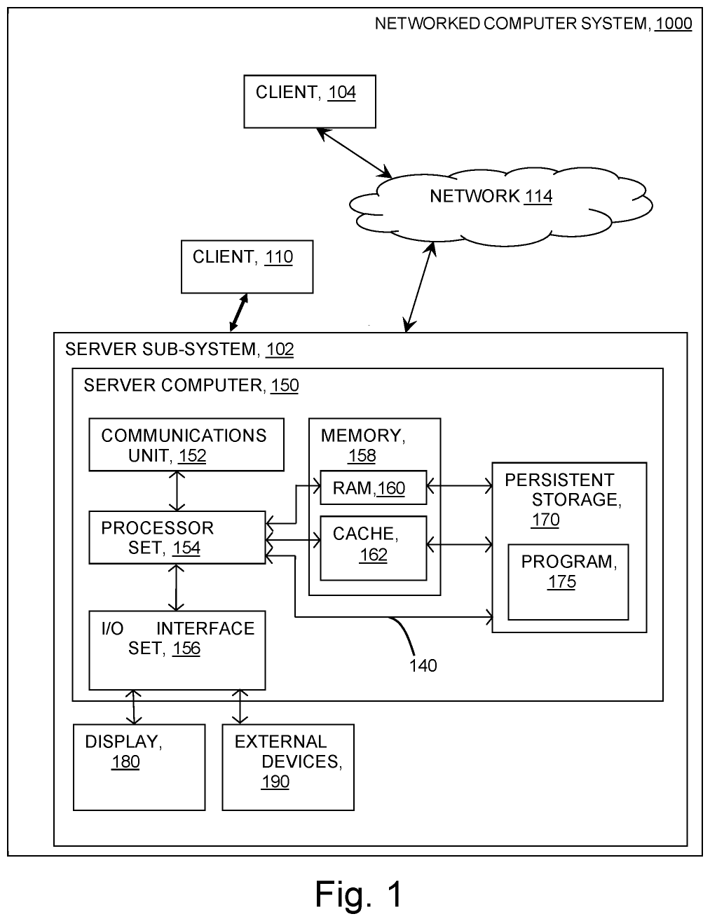

FIG. 1 provides a schematic illustration of exemplary network resources associated with practicing the disclosed inventions. The inventions may be practiced in the processors of any of the disclosed elements which process an instruction stream. As shown in the figure, a networked Client device 110 connects wirelessly to server sub-system 102. Client device 104 connects wirelessly to server sub-system 102 via network 114. Client devices 104 and 110 comprise timeseries data set selection program (not shown) together with sufficient computing resource (processor, memory, network communications hardware) to execute the program. As shown in FIG. 1, server sub-system 102 comprises a server computer 150. FIG. 1 depicts a block diagram of components of server computer 150 within a networked computer system 1000, in accordance with an embodiment of the present invention. It should be appreciated that FIG. 1 provides only an illustration of one implementation and does not imply any limitations with regard to the environments in which different embodiments can be implemented. Many modifications to the depicted environment can be made.

Server computer 150 can include processor(s) 154, memory 158, persistent storage 170, communications unit 152, input/output (I/O) interface(s) 156 and communications fabric 140. Communications fabric 140 provides communications between cache 162, memory 158, persistent storage 170, communications unit 152, and input/output (I/O) interface(s) 156. Communications fabric 140 can be implemented with any architecture designed for passing data and/or control information between processors (such as microprocessors, communications and network processors, etc.), system memory, peripheral devices, and any other hardware components within a system. For example, communications fabric 140 can be implemented with one or more buses.

Memory 158 and persistent storage 170 are computer readable storage media. In this embodiment, memory 158 includes random access memory (RAM) 160. In general, memory 158 can include any suitable volatile or non-volatile computer readable storage media. Cache 162 is a fast memory that enhances the performance of processor(s) 154 by holding recently accessed data, and data near recently accessed data, from memory 158.

Program instructions and data used to practice embodiments of the present invention, e.g., the training data set selection program 175, are stored in persistent storage 170 for execution and/or access by one or more of the respective processor(s) 154 of server computer 150 via cache 162. In this embodiment, persistent storage 170 includes a magnetic hard disk drive. Alternatively, or in addition to a magnetic hard disk drive, persistent storage 170 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 170 may also be removable. For example, a removable hard drive may be used for persistent storage 170. Other examples include optical and magnetic disks, thumb drives, and smart cards that are inserted into a drive for transfer onto another computer readable storage medium that is also part of persistent storage 170.

Communications unit 152, in these examples, provides for communications with other data processing systems or devices, including resources of client computing devices 104, and 110. In these examples, communications unit 152 includes one or more network interface cards. Communications unit 152 may provide communications through the use of either or both physical and wireless communications links. Software distribution programs, and other programs and data used for implementation of the present invention, may be downloaded to persistent storage 170 of server computer 150 through communications unit 152.

I/O interface(s) 156 allows for input and output of data with other devices that may be connected to server computer 150. For example, I/O interface(s) 156 may provide a connection to external device(s) 190 such as a keyboard, a keypad, a touch screen, a microphone, a digital camera, and/or some other suitable input device. External device(s) 190 can also include portable computer readable storage media such as, for example, thumb drives, portable optical or magnetic disks, and memory cards. Software and data used to practice embodiments of the present invention, e.g., training data set selection program 175 on server computer 150, can be stored on such portable computer readable storage media and can be loaded onto persistent storage 170 via I/O interface(s) 156. I/O interface(s) 156 also connect to a display 180.

Display 180 provides a mechanism to display data to a user and may be, for example, a computer monitor. Display 180 can also function as a touch screen, such as a display of a tablet computer.

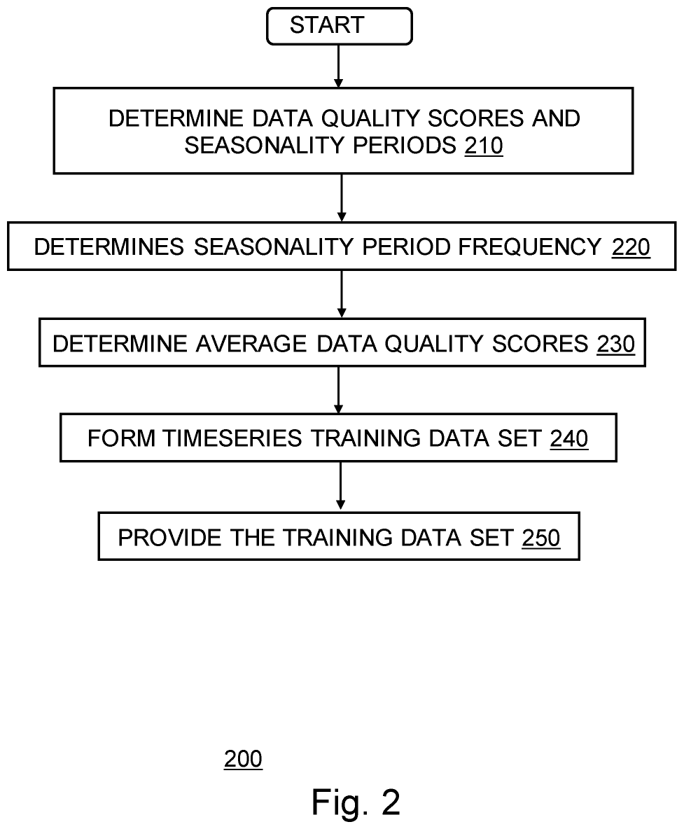

FIG. 2 provides a flowchart 200, illustrating exemplary activities associated with the practice of the disclosure. After program start, at block 210 the method of training data set selection program 175, executing by way of one or more computer processors such as those illustrated in FIG. 1, determines a data quality score and a seasonality period for each data segment of a received set of timeseries data associated with a destination machine learning model. The method further receives a set of data quality attribute weights for the set of timeseries data associated with, and derived from, the relative importance of each data quality attribute to the destination machine learning model. The method uses a sliding window in dividing the received timeseries data set into segments for the evaluation of the data quality score and seasonality period for each segment. In an embodiment, the method evaluates the data set using a single fixed sliding window length, such as a fourteen-day window. In an embodiment, the method evaluates the data set using a plurality of different sliding window lengths, one day, one week, fourteen days, etc. Each sliding window evaluation yields a set of data segments, each segment having a data quality score and a seasonality period.

At block 220, the method determines the frequency of each identified seasonality period across the set of evaluated timeseries data segments. The method identifies the most frequently occurring seasonality period for the set of segments.

At block 230, the method determines the average data quality score of the set of segments having the most frequently occurring seasonality period. The method receives a desired data quality score for the selected training data set from a user. The method compares the average data quality score for the set of segments having the most frequently occurring seasonality period to the desired data quality score.

At block 240 the method forms a training data set from segments having the most frequently occurring seasonality period. For sets of such segments having an average data quality score equal to or exceeding the desired data quality score, the method forms a training data set by merging all segments in the set of segments having the most frequently occurring seasonality period. For sets having an average data quality score less than the desired data quality score, the method determines the media quality score for the set and forms the training data set by merging all segments having an individual data quality score greater than the median data quality score for the set of segments having the most frequent seasonality period.

At block 250 the method provides the formed training data set to the user for training the machine learning model. In an embodiment, the user reserves a portion of the formed training data set for use as a test data set for validating the trained machine learning model.

### EXAMPLE

Table one provides data associated with twenty-seven data segments having a seasonality period of twenty-four hours, the most frequent seasonality period for the entire set of evaluated segments. The example has a desired data quality score of 80% while the subset of data segments has an average data quality score of only 73%. For the example, the method determines the median quality score for the subset (0.66 or 66%) and merges the segments having a data quality score greater than 66% (0.66), to form the training data set.

TABLE 1

| Seasonality period | Dq score | Start date | End date |
|---|---|---|---|
| 24 hours | 0.66 | 1 | 15 |
| | 0.66 | 2 | 16 |
| | 0.66 | 3 | 17 |
| | 0.66 | 4 | 18 |
| | 0.66 | 5 | 19 |
| | 0.66 | 6 | 20 |
| | 0.66 | 7 | 21 |
| | 0.66 | 8 | 22 |
| | 0.66 | 9 | 23 |
| | 0.66 | 10 | 24 |
| | 0.66 | 11 | 25 |
| | 0.66 | 12 | 26 |
| | 0.66 | 13 | 27 |
| | 0.66 | 14 | 28 |
| | 0.67 | 15 | 29 |
| | 0.69 | 16 | 30 |
| | 0.71 | 17 | 31 |
| | 0.73 | 18 | 32 |
| | 0.76 | 19 | 33 |
| | 0.78 | 20 | 34 |
| | 0.8 | 21 | 35 |
| | 0.82 | 22 | 36 |
| | 0.84 | 23 | 37 |
| | 0.87 | 24 | 38 |
| | 1 | 31 | 45 |
| | 1 | 34 | 48 |
| | 1 | 37 | 51 |

For the example, tables two, three and four present data segments associated with seasonal periods other than the most frequent seasonal period. Though these subsets have average data quality scores exceeding the desired data quality score of 80%, the method ignores these segments in forming the training data set as the segments are not associated with the most frequent seasonality period of the overall data set.

TABLE 2

| Seasonality period | Dq score | Start date | End date |
|---|---|---|---|
| 168 hours | 0.91 | 26 | 40 |
| | 0.93 | 27 | 41 |
| | 0.96 | 28 | 42 |
| | 0.98 | 29 | 43 |

TABLE 3

| Seasonality period | Dq score | Start date | End date |
|---|---|---|---|
| 9 hours | 1 | 32 | 46 |
| 16 hours | 0.89 | 25 | 39 |
| 169 hours | 0.89 | 25 | 39 |
| 71 hours | 0.96 | 42 | 56 |
| 253 hours | 1 | 38 | 52 |
| 270 hours | 1 | 36 | 50 |
| 271 hours | 1 | 35 | 49 |

TABLE 4

| Seasonality period | Dq score | Start date | End date |
|---|---|---|---|
| 72 hours | 1 | 39 | 53 |
| | 0.96 | 40 | 54 |
| | 0.96 | 41 | 55 |
| | 0.96 | 43 | 57 |
| | 0.96 | 44 | 58 |

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed. In an embodiment, local computing resources may prove insufficient for the necessary steps of selecting the timeseries training data set. For such an embodiment, the method may utilize networked resources including edge cloud and cloud computing resources.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

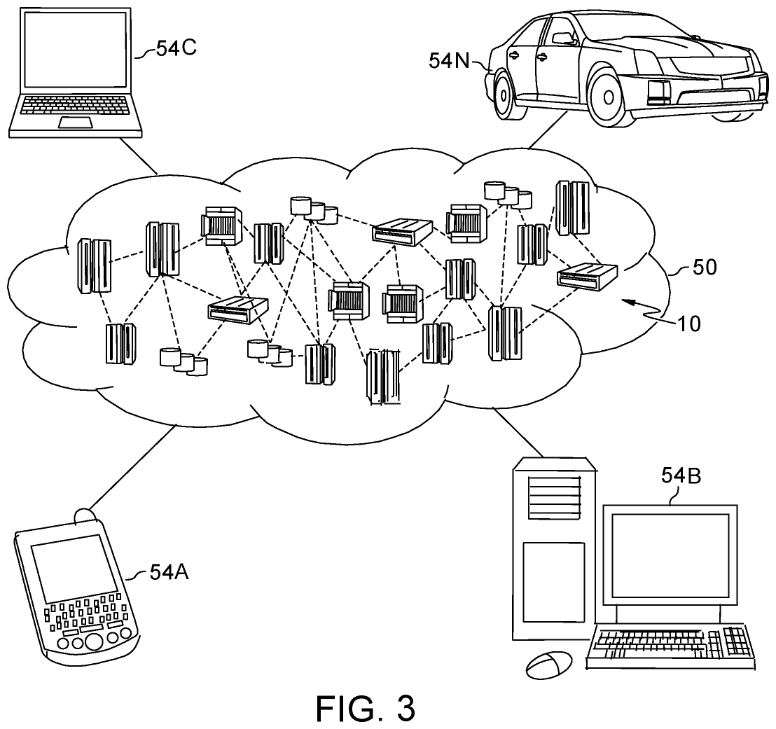

Referring now to FIG. 3, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 3 are intended to be illustrative only and that computing nodes 10 and cloud computing environment 50 can communicate with any type of computerized device over any type of network and/or network addressable connection (e.g., using a web browser).

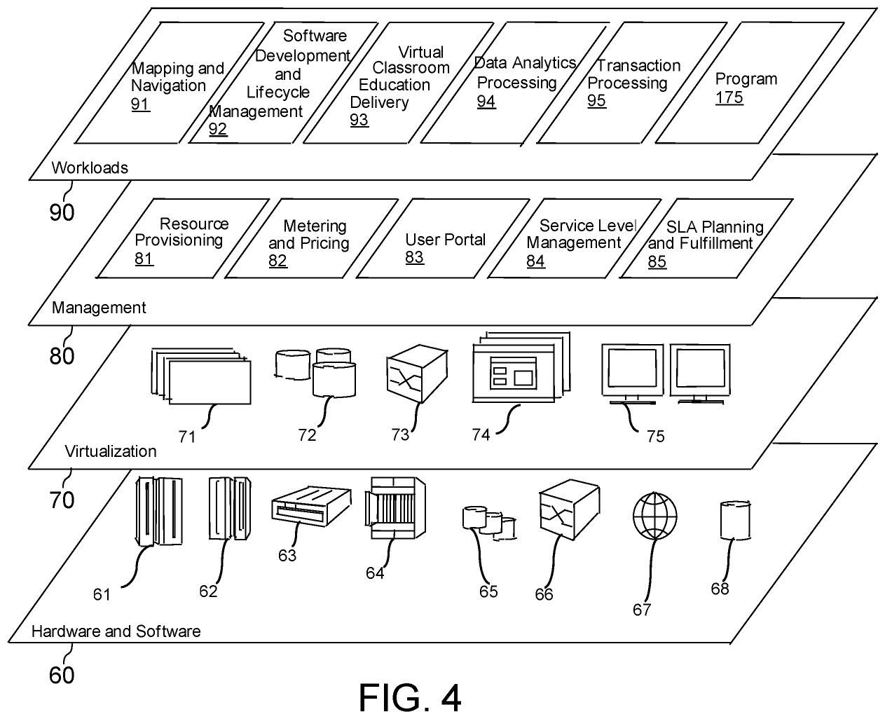

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and training data set selection program 175.

The present invention may be a system, a method, and/or a computer program product at any possible technical detail level of integration. The invention may be beneficially practiced in any system, single or parallel, which processes an instruction stream. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, or computer readable storage device, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions collectively stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method for selecting a timeseries data set, the method comprising:
determining, by one or more computer processors, a data quality score and seasonality period for each segment of a set of timeseries data segments;
determining, by the one or more computer processors, a most frequent seasonality period for the set of timeseries data segments;
determining, by the one or more computer processors, an average data quality score for a set of timeseries data segments having the most frequent seasonality period;
forming, by the one or more computer processors, a timeseries data set from segments having the most frequent seasonality period, according to a desired data quality score; and
providing, by the one or more computer processors, the timeseries data set for training a machine learning model.

2. The computer implemented method according to claim 1, wherein:
forming the timeseries data set comprises merging the segments of the set of timeseries data segments having the most frequent seasonality period.

3. The computer implemented method according to claim 1, wherein:
forming the timeseries data set comprises merging segments, of the set of timeseries data segments having the most frequent seasonality period, having a data quality score exceeding a median data quality score for all the segments of the set.

4. The computer implemented method according to claim 1, wherein the data quality score relates to data attributes associated with the machine learning model.

5. The computer implemented method according to claim 1, wherein the data quality score comprises a weighted score across a set of data attributes associated with the machine learning model.

6. The computer implemented method according to claim 1, further comprising using, by the one or more computer processors, at least one sliding window to determine the seasonality period of a segment.

7. The computer implemented method according to claim 1, further comprising training, by the one or more computer processors, the machine learning model using the timeseries data set.

8. A computer program product for selecting a timeseries data set, the computer program product comprising one or more computer readable storage devices and collectively stored program instructions on the one or more computer readable storage devices, the stored program instructions comprising:
program instructions to determine a data quality score and seasonality period for each segment of a set of timeseries data segments;
program instructions to determine a most frequent seasonality period for the set of timeseries data segments;
program instructions to determine an average data quality score for a set of timeseries data segments having the most frequent seasonality period;
program instructions to form a timeseries data set from segments having the most frequent seasonality period, according to a desired data quality score; and
program instructions to provide the timeseries data set for training a machine learning model.

9. The computer program product according to claim 8, wherein:
program instructions to form the timeseries data set comprise program instructions to merge the segments of the set of timeseries data segments having the most frequent seasonality period.

10. The computer program product according to claim 8, wherein:
program instructions to form the timeseries data set comprise program instructions to merge segments, of the set of timeseries data segments having the most frequent seasonality period, having a data quality score exceeding a median data quality score for all the segments of the set.

11. The computer program product according to claim 8, wherein the data quality score relates to data attributes associated with the machine learning model.

12. The computer program product according to claim 8, wherein the data quality score comprises a weighted score across a set of data attributes associated with the machine learning model.

13. The computer program product according to claim 8, the stored program instructions further comprising program instructions to use at least one sliding window to determine the seasonality period of a segment.

14. The computer program product according to claim 8, the stored program instructions further comprising program instructions to train the machine learning model using the timeseries data set.

15. A computer system for selecting a timeseries data set, the computer system comprising:
one or more computer processors;
one or more computer readable storage devices; and
stored program instructions on the one or more computer readable storage devices for execution by the one or more computer processors, the stored program instructions comprising:
program instructions to determine a data quality score and seasonality period for each segment of a set of timeseries data segments;
program instructions to determine a most frequent seasonality period for the set of timeseries data segments;
program instructions to determine an average data quality score for a set of timeseries data segments having the most frequent seasonality period;
program instructions to form a timeseries data set from segments having the most frequent seasonality period, according to a desired data quality score; and
program instructions to provide the timeseries data set for training a machine learning model.

16. The computer system according to claim 15, wherein:
program instructions to form the timeseries data set comprise program instructions to merge the segments of the set of timeseries data segments having the most frequent seasonality period.

17. The computer system according to claim 15, wherein:
program instructions to form the timeseries data set comprise program instructions to merge segments, of the set of timeseries data segments having the most frequent seasonality period, having a data quality score exceeding a median data quality score for all the segments of the set.

18. The computer system according to claim 15, wherein the data quality score relates to data attributes associated with the machine learning model.

19. The computer system according to claim 15, wherein the data quality score comprises a weighted score across a set of data attributes associated with the machine learning model.

20. The computer system according to claim 15, the stored program instructions further comprising program instructions to use at least one sliding window to determine the seasonality period of a segment.
